(19) United States
(12) Patent Application Publication
(10) Pub. No.: US 2026/0296866 A1
(43) Pub. Date: Oct. 1, 2026

(54) INSULATED CAPPING HEAD

(71) Applicant: AROL S.P.A., Canelli (AT) (IT)

(72) Inventors: Andrea GALLO, Canelli (AT) (IT); Massimiliano SCAGLIONE, Canelli (AT) (IT)

(21) Appl. No.: 19/481,217

(22) PCT Filed: Apr. 30, 2024
(86) PCT No.: PCT/IB2024/054187

§ 371 Date: Nov. 4, 2025

(30) Foreign Application Priority Data
May 4, 2023 (IT) 102023000008910

(51) Int. Cl. B67B 3/18

(52) U.S. Cl. CPC B67B 3/18

(57) ABSTRACT

A capping head for applying caps onto containers is provided generally comprises a substantially vertically extending support structure, in which a lower base and an upper base are defined connected to each other by a vertical slide guide, a mouth presser having a vertical axis and rotatably associated with the lower base of the capping head for exerting a predetermined pressure onto a cap fitted on the mouth of a container located under the mouth presser, and at least one pivoting arm which is provided with a threading roller or knurling roller, is hinged to the support structure and can take a rest configuration, in which the roller is distal to the vertical axis of the mouth presser, and a working configuration, in which the roller is proximal to the vertical axis. A drive cam is provided for driving the pivoting motion of the arm.

### TECHNICAL FIELD

The present invention relates to an insulated capping head for applying caps onto bottles or containers in general, a capping machine comprising such head, and a method that is intended for applying caps and can be carried out by means of such machine.

Caps for bottles and containers in general have a cylindrical wall made of a deformable metal material, for example, aluminum or the like, said wall being subjected to a step of cold plastic deformation by threading and rolling or knurling, after the cap has been deep-drawn on the mouth of the container.

Caps for container generally comprise a flat head surface and a substantially cylindrical lateral surface. Within the cap, a yielding, usually disc-shaped, sealing gasket or ‘liner’ is received under the flat head surface, said sealing gasket being capable of ensuring hydraulic tightness against the mouth of the container when the cap is pressed against the front edge of the container mouth. The lateral surface of the cap comprises a jacket which is made of a plastically deformable metal material and matches the thread provided on the container mouth.

The operations of deep-drawing, threading and rolling or knurling deform a corresponding annular portion of the lateral surface of the cap against corresponding annular grooves provided on the mouth and neck of the container.

### BACKGROUND ART

Technologies are known for applying aluminum caps to a bottle or container so that, after this operation, the cap is firmly anchored to the bottle, thereby ensuring tightness against a liquid or powder contained therein.

Known capping heads comprise a cap-holding body arranged to press axially the cap onto the container neck, and a rotary equipment provided with threading and knurling rollers.

An example of a capping head of known type is described in CH 526 464. Another example of capping head to apply caps onto containers is described in U.S. Pat. No. 3,076,300 A.

Known devices are not insulated and are not applicable in an environment, e.g., an aseptic or sterile environment, where the area through which the vessel passes is required to be insulated from contaminants coming from the capping head.

Known capping heads have significant problems due to the possible contamination of the processed product as a result of the loss of contaminants such as lubricants. Moreover, known devices have parts that are susceptible to create receptacles that are difficult to access and cause bacterial proliferation that can then form in all parts that are not completely washable and/or sterilizable with chemical agents or pressurized steam.

Known devices have many parts that are not exposed to a sterilizing operation and, during operation of the capping machine, get cyclically uncovered and concealed, thereby getting accessible to contaminants and becoming stagnation areas that cannot be easily washed.

A first object of the invention is therefore to provide a capping head that is suitable for being used in environments that require the area through which the vessel passes to be insulated from the risk of getting contaminated by contaminants from the capping machine.

Another object of the invention is to provide a capping head that can be used in aseptic or sterile environments.

A further object of the invention is to provide a capping head that can be cleaned in an easy and effective manner.

A not least object of the invention is to provide a capping head, a capping machine comprising such head, and a capping method that can be carried out by means of said machine, which capping head, capping machine and capping method need to be industrially implementable in a cost-effective manner and reliable over time even when they are adopted in industrial working cycles with high and ultra-high production speeds.

### SUMMARY OF INVENTION

The problems outlined above are advantageously solved by the invention in accordance with what is claimed in the appended claims.

The capping head according to the invention for applying caps onto containers in general can advantageously be applied to a capping machine and be employed in a container capping method where a high cleanliness standard is required, for example, for treating products in liquid or powder form that require an aseptic and sterile environment.

The capping head according to the invention generally comprises a substantially vertically extending support structure having a lower base and an upper base that are connected to each other by a vertical slide guide.

Preferably, according to the invention, the support structure as a whole has a substantially cylindrical shape extending vertically, and the slide guide is arranged at the circumferential periphery of the support structure and is secured to the opposite lower and upper bases, preferably at the perimeter of these bases.

In a preferred embodiment of the invention, the slide guide consists of at least one vertical column, preferably a series of vertical columns, for example, four columns, with their respective ends secured to the opposite lower and upper bases of the support structure.

The vertical columns and the other parts of the capping head are preferably made of stainless steel, and bushings made of a plastic material may be provided thereon, said bushings being provided with longitudinal grooves to facilitate passage of the washing liquid during any operations of washing the capping head.

The lower and upper bases of the support structure can, for example, be circular in plan, or have different geometric shapes, e.g., a square or oval shape. Preferably, the opposite bases further comprise a solid body.

The capping head according to the invention further comprises a mouth presser having a vertical axis and being rotatably associated with the lower base of the capping head for exerting a predetermined pressure onto a cap fitted on the mouth of a container located under the mouth presser.

At least one pivoting arm provided with an idly rotatable threading roller or knurling roller is hinged to the support structure. Said arm can take a rest configuration, in which the roller is distal to the vertical axis of the mouth presser, and a working configuration, in which the roller is proximal to said vertical axis.

Preferably, four pivoting arms are provided, namely, two equipped with threading rollers and two with knurling rollers. The pivoting arms are preferably hinged to the outside of the support structure and extend downwards beyond the lower base of the capping head to reach, with their corresponding rollers, the neck of the container when the container is arranged with its mouth inserted in the mouth presser for applying the cap.

According to the invention, the capping head comprises a drive cam for driving the pivoting motion of the arm. The drive cam is slidable, relative to the slide guide, between a position corresponding to the rest configuration and a position corresponding to a working configuration of the arm.

Furthermore, still according to the invention, the capping head comprises a central housing provided with at least one deformable or extendable portion, for example, a flexible or telescopic portion, in which a chamber insulated from the outer environment is defined, said chamber housing at least one movable member capable of imparting the sliding motion to said drive cam. Support members capable of rotatably supporting the support structure, for example, by interposing ball bearings or bushings, are received inside the housing.

Preferably, the mouth presser comprises a cylindrical body open at its lower end and is secured to the end of a vertical shaft extending axially from the lower base of the support structure towards the upper base of said structure within the housing. Ball bearings or bushings are provided between the vertical shaft and the housing to allow relative rotation between the housing and the vertical shaft. In addition, preferably, the mouth presser is rotatably associated to the lower base of the support structure by interposing therebetween a sealing ring, so as to ensure that the chamber defined in the housing is insulated from the outer environment.

According to a preferred embodiment of the invention, the drive cam, in order to switch from the rest configuration to the working configuration, is operated by an actuating member extending vertically and capable of transferring to the drive cam the vertical motion imparted by an actuating assembly external to the capping head.

Even more preferably, the drive cam is connected, preferably in a rigid manner, to a control flange which can slide relative to the slide guide and onto which the vertical actuating member acts.

Preferably, sliding of the drive cam and of the control flange, if any, relative to the slide guide, takes place against the resistance of at least one elastic member, for example, a helical spring.

In a preferred embodiment of the invention, the central housing insulating the movable and rotatable support members comprises a vertical central barrel extending axially from the lower base inside the support structure towards the upper base.

The central housing further comprises a sliding ring coaxial with the axis of the central barrel and arranged between the upper base of the support structure and the central barrel.

Advantageously, a first bellows is provided between the sliding ring and the upper base, and a second bellows is provided between the sliding ring and the central barrel.

The two bellows may preferably be identical to each other and mirror arranged relative to the sliding ring and made, for example, of rubber.

Advantageously, according to the invention, sliding of the ring along the vertical axis of the support structure is caused by an actuating member housed within the housing. The ring is connected, externally relative to the central housing, to the drive cam, preferably by means of the control flange sliding axially relative to the slide guide. Therefore, advantageously, the axial motion of the actuating member housed within the housing is transferred, by means of the sliding ring, to the drive cam located outside the housing.

The central barrel, the pair of bellows and the sliding ring together, and according to a preferred embodiment of the invention, form the housing surrounding the insulated chamber in which the actuating member and the rotatable support members of the support structure are received.

The environment in which the drive cam driving the arms operates is therefore insulated from the inner chamber of the housing and is consequently free from contamination that may be caused by the substances present inside the chamber in which the member actuating the vertical motion of the cam and the members rotatably supporting the support structure operate.

According to the invention, the environment outside the insulated chamber provided within the housing is fully accessible by the agents used for washing, sanitizing and sterilizing the capping head, without the risk of these agents damaging the parts received within the housing.

According to the invention, the drive cam preferably comprises a frustoconical body, preferably hollow, which is coaxial with the central axis of the support structure, has its lower base oriented downwards and is slidably associated with the slide guide of the support structure.

Furthermore, according to the invention, the drive cam does not interfere with the outer wall of the housing and can therefore slide vertically with no interference. Also, the clearance provided between the drive cam and the outer wall of the housing allows easy passage of washing and disinfecting liquids, which can therefore be easily used for cleaning the capping head.

The capping head according to the present invention is advantageously susceptible to combined threading and rolling or knurling operations.

Advantageously, the capping head according to the invention incorporates structural features such that it can be applied in an aseptic or sterile environment.

Specifically, the capping head according to the invention provides that the mechanical parts that move during working are in communication only with the part of non-aseptic environment, thereby being insulated from the aseptic environment.

Advantageously, according to a preferred embodiment of the invention, this result is achieved by creating an area in which the mechanical parts are insulated from the part exposed to the aseptic environment thanks to a cam motion induced by a control flange and thanks to a part rotating on ball bearings.

Furthermore, advantageously, the separation of the control flange is obtained by means of two bellows that are preferably identical to each other and mirror mounted.

In addition, advantageously, according to the invention the drive cam for driving the threading and knurling arms does not come into direct contact with the lower barrel providing rotatable support, thereby allowing passage of the washing liquids.

### BRIEF DESCRIPTION OF DRAWINGS

Some preferred embodiments of the invention will be provided by way of non-limiting examples with reference to the annexed drawings, in which:

FIG. 1 is a perspective view of the capping head according to a preferred embodiment of the invention;

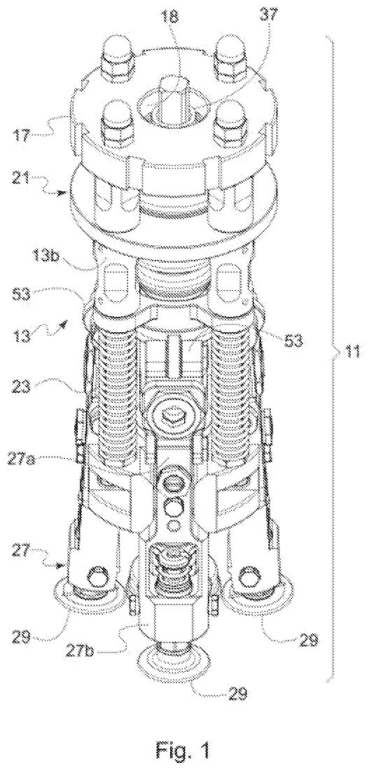

FIG. 2 is a section along a longitudinal plane of the capping head of FIG. 1;

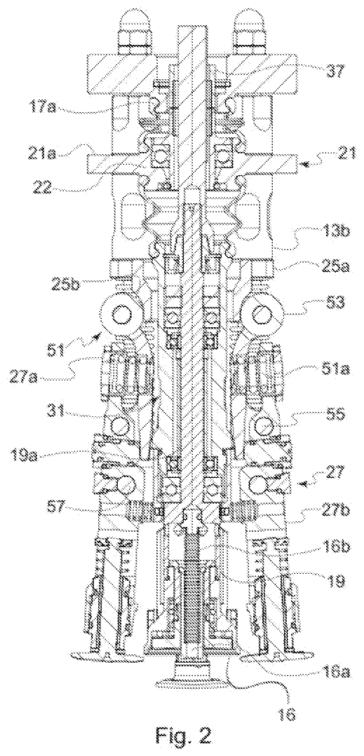

FIG. 3 is a section along a longitudinal plane of the support structure of the capping head of FIG. 1;

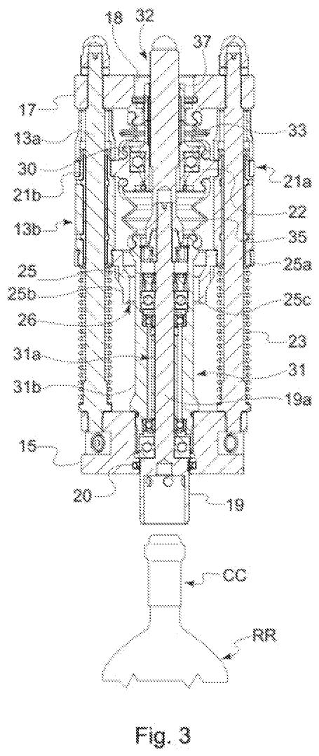

FIG. 4 is a schematic perspective view of a capping machine incorporating the capping head of FIG. 1.

### DESCRIPTION OF EMBODIMENTS

Referring to the annexed figures, these illustrate a preferred embodiment of the capping head 11 for applying caps CC to containers RR in general, for example, bottles.

The capping head 11 for applying caps to containers in general according to the invention mainly comprises a substantially vertically extending support structure 13 having a lower base 15 and an upper base 17 which are connected to each other by a vertical slide guide.

In the illustrated embodiment, the support structure 13 as a whole has a substantially cylindrical shape extending vertically, and the slide guide is arranged at the circumferential periphery of the capping head 11 and is secured to the opposite lower 15 and upper 17 bases, next the perimeter of these bases.

Still referring to this embodiment, the slide guide is represented by a series of four vertical columns 13a whose respective ends are secured to the opposite lower 15 and upper 17 bases of the support structure 13.

These four parallel axial cylindrical columns 13a are arranged about the capping head 11 along corresponding generatrixes having a mutual angular distance of about 90°.

The columns 13a are secured to the lower base 15 by screwing the lower ends of the columns into the body of the base 15, and to the upper base 17 by means of corresponding locking nuts.

The lower base 15 and the upper base 17 of the support structure 13, in the illustrated embodiment, are circular in plan and are defined by a corresponding solid body.

The capping head 11 according to the invention further comprises a mouth presser 16 having a vertical axis and being rotatably associated with the lower base 15 of the capping head 11 by means of a sleeve 19.

The mouth presser 16 is arranged to exert a predetermined pressure onto a cap CC fitted on the mouth of a container RR located under the mouth presser 16, when the capping head 11 is brought against the mouth of the container RR.

At least one pivoting arm 27, which is provided with a threading roller or knurling roller 29, is hinged to the support structure 13. Said arm 27 can take a rest configuration, in which the roller 29 is distal to the vertical axis of the mouth presser 16, and a working configuration, in which the roller 29 is proximal to said vertical axis.

In the illustrated embodiment, four pivoting arms 27 are provided, namely, two equipped with threading rollers and two with knurling rollers. The arms 27 are preferably hinged to the outside of the support structure 13 and extend downwards beyond the lower base 15 of the capping head 11 to reach, with their corresponding rollers 29, the neck of the container RR when said container is arranged with its mouth inserted in the mouth presser 16 for applying the cap CC.

The capping head 11 shown comprises a drive cam 25 for driving the pivoting motion of the arm 27. The drive cam 25 is slidable, relative to the slide guide, between a position corresponding to the rest configuration of the arm 27, and a position corresponding to a working configuration of the arm 27. In the illustrated embodiment, the first configuration corresponds to a position in which the cam 25 is proximal to the upper base 17 and the second configuration corresponds to a position in which the cam 25 is proximal to the lower base 15.

In addition, the capping head 11 shown comprises a central housing 31 provided with at least one flexible portion, in which a chamber 31a insulated from the outer environment is defined. Said chamber 31a houses at least one movable member 37 capable of imparting the sliding motion to said drive cam 25.

The mouth presser 16 comprises a frustoconical body open at its lower end and is secured to the end of a vertical shaft 19a extending axially from the lower base 15 of the support structure 13 towards the upper base 17 within the housing 31. Ball bearings are provided between the vertical shaft 19a and the housing 31 to allow relative rotation between the housing 31 and the vertical shaft 19a.

Moreover, the shaft 19a is rotatably associated with the lower base 15 of the support structure 13 by interposing therebetween a sealing ring 20, so as to ensure that the chamber 31a defined in the housing 31 is insulated from the outer environment.

The drive cam 25, in order to switch from the rest configuration to the working configuration, is operated by the actuating member 37 extending vertically and capable of transferring to the drive cam 25 the vertical motion imparted by an actuating assembly external to the capping head 11.

In the illustrated embodiment, the drive cam 25 is connected to a control flange 21 which can slide relative to the slide guide and onto which the vertical actuating member 37 acts.

Sliding of the drive cam 25 and of the control flange 21 relative to the slide guide takes place against the resistance of elastic members, comprising a helical spring 23.

The central housing 31 insulating the movable and rotatable support members comprises a vertical central barrel 31b extending axially from the lower base 15 inside the support structure 13 towards the upper base 17.

The central housing 31 further comprises a sliding ring 22 coaxial with the axis of the central barrel 31b and arranged between the upper base 17 and the central barrel 31b.

A first bellows 33 is provided between the sliding ring 22 and the upper base 17, and a second bellows 35 is provided between the sliding ring 22 and the central barrel 31b.

In this embodiment, the bellows 33 and 35 are preferably identical to each other and mirror arranged relative to the sliding ring 22.

In the illustrated embodiment, the ring 22 is integrated in the control flange 21 and forms a single body therewith.

Sliding of the ring 22 along the vertical axis of the support structure 13 is caused by the actuating member 37 housed within the central housing 21. The ring 22 is connected, externally, to the drive cam 25 by means of the control flange 21 sliding relative to the slide guide.

The axial motion of the actuating member 37 housed within the housing 31a is transferred, by means of the sliding ring 22 integrated in the control flange 21, to the drive cam 25 located outside the housing 31.

The central barrel 31b, the pair of bellows 33 and 35 and the sliding ring 22 together, and according to the illustrated embodiment of the invention, form the insulating housing 31 surrounding the chamber 31a in which the actuating member 37 and the rotatable support members of the support structure are received.

Said rotatable support members comprise ball bearings 30 or low friction coefficient inserts to allow relative rotation between the housing 31 and an upper support shaft 32 coaxial with the housing 31 and a lower support shaft 19a coaxial with the upper shaft 32.

The environment in which the drive cam driving the arms operates is therefore insulated from the inner chamber 31a of the housing 31 and is consequently free from contamination that may be caused by the substances present inside the chamber 31a in which the member 37 actuating the vertical motion of the cam 25 and the members rotatably supporting the support structure 13 operate.

The cam 25 in the illustrated embodiment comprises a frustoconical body which has its lower base 25c oriented downwards and is slidably associated with the slide guide of the support structure 13.

In addition, the drive cam 25 does not interfere with the outer wall of the housing 31 and can therefore slide vertically with no interference. Also, the clearance 26 provided between the drive cam 25 and the outer wall of the housing 31 allows easy passage of washing and disinfecting liquids which may be used for cleaning the capping head 11.

In this illustrated embodiment, the mouth presser 16 is secured to a vertical shaft 19a which is rotatably supported by means of bearings in an opening provided in the lower base 15 of the support structure 13 in a substantially central position.

The control flange 21 comprises a slider 21a passed through by the columns 13a and capable of sliding axially on the columns 13a due to the presence of sliding bushings 21b.

In the illustrated embodiment, the sliding drive cam 25 comprises a slider 25a passed through by the columns 13a and capable of sliding axially on the columns 13a due to the presence of the sliding bushings 21b. Still referring to the illustrated embodiment, the slider 25a is connected to the slider 21a of the control flange 21 by means of sleeves 13b sliding on the bushings 21b along the columns 13a.

A helical spring 23 is provided for each column 13a to counteract the downward motion of the sliders 21a and 25a, and the load imparted to the springs determines the pressure of the mouth presser 16 against the mouth of the container, for example, a glass bottle, to cause deep-drawing of the gasket provided inside the cap CC.

For each pivoting arm 27 an actuating lever 51 is provided cooperating, through a rotating wheel 53, with the cam surface 25b of the sliding cam 25 in order to actuate the corresponding pivoting arm 27. According to this embodiment of the invention, the actuating levers 51 are hinged to the pivoting arms 27 by means of corresponding hinge pins 55 and are configured as second-class levers. The pivoting arms 27 are hinged to the support structure 13 by means of corresponding hinge pins 57 and are configured as first-class levers. The pivoting arm 27 are thus provided with an upper section 27a and a lower section 27b relative to the hinge pin 57.

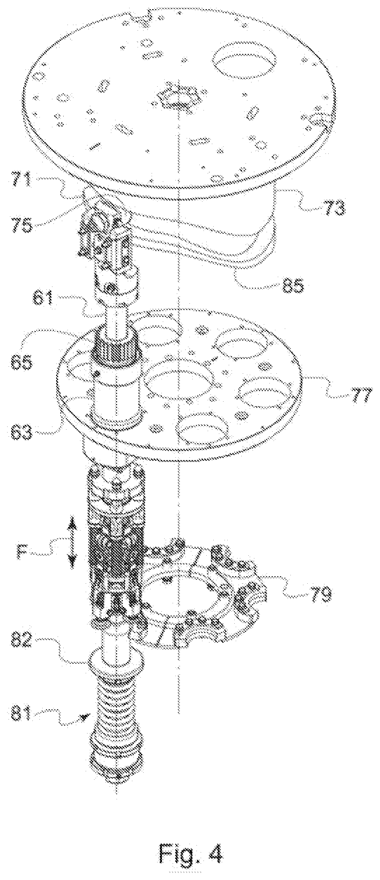

Referring to FIG. 4, in the shown preferred embodiment, the operation of the capping head 11 according to the invention takes place in the following manner.

The support structure 13 of the capping head 11 is lowered vertically along a direction substantially parallel to the vertical axis of the structure 13 (arrow F). The lowering of the support structure 13 is determined by the descending motion of a motor-driven rotating vertical axis 61 associated with the upper base 17 at a seat 18 provided therein. The rotating axis 61 is also arranged to cause rotation of the support structure 13 of the capping head 11 about its vertical axis. Said rotating axis 61 may, for example, correspond with the axis of rotating piston 63 rotated by an electric motor by means of gears 65.

The descending and ascending motion of the motor-driven rotating axis 61 is in turn caused by the cooperation between the tracks formed on the opposite face of a cam guide 71 extending circumferentially about a turret 73 of the capping machine, with a follower roller 75 rotatably connected to the upper end of the motor-driven rotating axis 61 by means of vertical rod. The vertical rod is decoupled, in the rotation motion, from the motor-driven rotating axis 61 by means of bushings. The cam follower roller 75 follows the track of the cam guide 71 in the rotation motion of the piston 63 about the turret 73. In an exemplary configuration of the capping machine, the piston 63 is secured to a piston-holding flange 77 which during the rotation motion carries with it a plurality of pistons 63 and capping heads 11.

In the vertical descending motion of the capping head 11, the mouth presser 16 which is provided substantially at the center of the structure 13 and under said structure, with the opening oriented downwards under the base 15, is brought against the mouth of a container RR, for example, a bottle, on which a cap CC made of metal, for example, aluminum, has already been fitted. Typically, in an automated production facility, the container picks up the cap from a delivery head attached to a cap-feeding channel and reaches the capping station, in which the capping head according to the invention operates, by means of a delivery star wheel 79 with the cap CC fitted on the mouth and ready to be threaded around the bottle neck and sealed inferiorly under the neck finish, by knurling the material of the cap.

When the support structure 13 of the capping head 11 reaches the container of bottle RR, the mouth presser 16 is pressed against the base of the cap CC so as to exert a pressure sufficient to determine deep-drawing of the cap onto the mouth of the bottle and by making a sealing gasket or ‘liner’, with which the cap is usually equipped on its inside, adhere in a tightly sealed manner. The deep-drawing operation therefore results in the sealing gasket of the cap being copied on the mouth of the bottle. By adjusting the load of the springs 23 of the columns 13a of the support structure 13 and/or od the spring 81 usually provided under a disc plate 82 supporting the container RR from below on a rotary table during the capping operation, it is possible to adjust the corresponding load value allocated to the mouth presser 16 to cause correct deep-drawing of the cap.

When the support structure 13 is in a condition in which the mouth presser 16 is pressed against the cap CC present on the bottle RR, and while the support structure 13 is constantly kept rotating by the motor-driven rotating axis 61, the vertical downward motion of a vertical control rod controlling the drive cam driving the arms causes lowering of the actuating member 37 acting on the control flange 21 housed in the support structure 13. This vertical motion of the control rod is caused by a lower track 85 of the cam guide 71 extending about the turret 73 of the capping machine.

The lowering of the control flange 21 consequently causes drive cam 25 for the arms to slide downwards, i.e., towards the container RR, in a direction proximal to the rollers 29 of the actuating levers 51 for the arms 27 carrying the threading and knurling rollers 29.

The downward sliding of the control flange 21 causes relaxation of the first bellows 33, or upper bellows, arranged between the control flange 21 and a stationary flange 17a located under the upper base 17 at the top of the support structure 13, and compression of the second bellows 35, or lower bellows, arranged between the control flange 21 and the lower barrel 31b provided in the support structure 13.

The downward sliding of the drive cam 25 of the actuating levers of the arms 27 causes the actuating levers 51 to move away in a radial direction towards the outside of the wheels 53 and causes, by means of the elastic member consisting of a helical spring, transfer of said radial outward motion to the upper sections 27a of the threading and knurling arms 27.

The actuating levers 51 are hinged to the arms 27 in corresponding hinge pins 55 and are configured as second-class levers. The arms 27 are hinged in corresponding hinge pins 57 and are configured as first-class levers, and the transfer of the shifting of the actuating levers on the upper sections of the arms causes the lower sections 27b of the arms 27, which are located on the opposite part of the hinge pin 57 with respect to upper sections, to move closer in a radial direction towards the center of the structure. The lower sections 27b of the arms 27 carry corresponding thread or knurling rollers 29, whose outer rims are carried against the surface of the cap CC as a result of the thrust imparted by the actuating levers 51.

The threading and knurling rollers 29 are both idly rotatable relative to corresponding rotation axis and are provided at the lower end of the arms 27. The arms 27, when closing on the container RR carrying a smooth cap CC ready to be processed, plastically deform the material of which the cap is made and, by coming into contact with the thread provided on the container neck, makes a duplicate negative copy of said thread on the cap CC. Simultaneously, the knurling rollers will retrace the profile of the neck finish of the container, thereby securing the seal of the cap.

During this step and in order to allow it to be correctly carried out, a piston 16a located at the center of the mouth presser 16 keeps the cap CC pressed as the mouth presser 16 moves closer to the mouth of the container. The piston 16a is elastically compressible in the axial direction against the resistance of a spring 16b. When the mouth presser 16 is resting on the base of the cap, the base of the cap CC is kept pressed by the piston 16a, while the wall of the base of the cap CC provided with a sealing gasket or ‘liner’ receives a thrust towards the mouth of the container with a vertical load equal to the one imparted by the spring 81 counteracting the compression of the disc plate 82.

### Industrial Applicability

The capping head according to the invention is suitable for being used in the industry of packaging products in liquid or powder form in containers of various kinds, for example, glass bottles.

The head according to the invention can be washed with washing liquids of various kind and can be sanitized in an autoclave or in-line, at high temperatures.

The invention as described is susceptible to numerous variations and modifications within the same inventive principle.

1. A capping head (11) for applying caps (CC) onto containers (RR), said capping head generally comprising a substantially vertically extending support structure (13), in which a lower base (15) and an upper base (17) are defined connected to each other by a vertical slide guide, a mouth presser (16) having a vertical axis and being rotatably associated with the lower base (15) of the capping head (11) for exerting a predetermined pressure onto a cap (CC) fitted on the mouth of a container (RR) located under the mouth presser (16), and at least one pivoting arm (27) which is provided with a threading roller or knurling roller (29), is hinged to the support structure (13) and can take a rest configuration, in which the roller (29) is distal to the vertical axis of the mouth presser (16), and a working configuration, in which the roller (29) is proximal to said vertical axis, characterized in that it comprises a drive cam (25) for driving the pivoting motion of the arm (27), said drive cam (25) being slidable relative to the slide guide between a position corresponding to the rest configuration of the arm (27) and a position corresponding to a working configuration of the arm (27), and a central housing (31), which extends axially inside the structure and is provided with at least one deformable portion and in which a chamber (31a) insulated from the outer environment is defined, said chamber housing a movable member (37) capable of imparting the sliding motion to said cam (25) located outside said central housing (31).

2. The capping head (11) according to claim 1, wherein the central housing (31) comprises:
a vertical central barrel (31b) extending axially from the lower base (15) inside the support structure (13) towards the upper base (17);
a sliding ring (22) coaxial with the axis of the central barrel (31b) and arranged between the upper base (17) of the support structure (13) and the central barrel (31b);
a first bellows (33) between the sliding ring (22) and the upper base (17); and
a second bellows (35) between the sliding ring (22) and the central barrel (31b).

3. The capping head (11) according to claim 2, wherein a control flange (21) is provided associated with the support structure (13) and axially sliding along the slide guide against the resistance of at least one elastic member (23), said control flange being connected to the drive cam (25), and wherein the sliding ring (22) is integrated in the control flange (21) and forms a single body therewith, and wherein the ring (22) is externally connected to the drive cam (25) by means of the control flange (21) sliding axially relative to the slide guide.

4. The capping head according to claim 3, wherein the support structure (13) altogether has a substantially cylindrical shape with vertical extension, and the slide guide is arranged on the circumferential periphery of said structure and is secured to the opposite lower (15) and upper (17) bases, and wherein the slide guide comprises parallel axial cylindrical columns (13a) arranged along corresponding generatrixes of the cylindrical body of the support structure (13), and wherein the elastic member (23) comprises a corresponding helical spring for each column (13a).

5. The capping head according to claim 4, wherein the control flange (21) comprises a slider (21a) passed through by the columns (13a) and capable of sliding axially on the columns (13a) due to the presence of sliding bushings (21b), and wherein the slidable drive cam (25) comprises a slider (25a) passed through by the columns (13a) and capable of sliding axially on the columns (13a) due to the presence of the sliding bushings (21b).

6. The capping head according to claim 5, wherein the slider (25a) of the drive cam is connected to the slider (21a) of the control flange by means of sleeves (13b) sliding on the bushings (21b) along the columns (13a) of the support structures (13).

7. The capping head according to claim 6, wherein the drive cam (25) comprises a frustoconical body which has its lower base oriented downwards and is slidably associated with the slide guide of the support structure (13), and wherein said drive cam (25) does not interfere with the outer wall of the housing (31) and can therefore slide vertically with no interference.

8. The capping head according to claim 7, wherein for each pivoting arm (27) an actuating lever (51) is provided cooperating, through a rotating wheel (53), with a cam surface (25b) of the sliding cam (25) in order to actuate the corresponding pivoting arm (27).

9. The capping head according to claim 8, wherein the actuating levers (51) are hinged to the pivoting arms (27) in corresponding hinge pins (55) and are configured as second-class levers, and wherein the pivoting arms (27) are hinged to the support structure (13) in corresponding hinge pins (57) and are configured as first-class levers.

10. A capping machine, characterized in that it comprises one or more capping heads according to claim 9.

11. The capping head (11) according to claim 1, wherein a control flange (21) is provided associated with the support structure (13) and axially sliding along the slide guide against the resistance of at least one elastic member (23), said control flange being connected to the drive cam (25), and wherein the sliding ring (22) is integrated in the control flange (21) and forms a single body therewith, and wherein the ring (22) is externally connected to the drive cam (25) by means of the control flange (21) sliding axially relative to the slide guide.

12. The capping head according to claim 11, wherein the support structure (13) altogether has a substantially cylindrical shape with vertical extension, and the slide guide is arranged on the circumferential periphery of said structure and is secured to the opposite lower (15) and upper (17) bases, and wherein the slide guide comprises parallel axial cylindrical columns (13a) arranged along corresponding generatrixes of the cylindrical body of the support structure (13), and wherein the elastic member (23) comprises a corresponding helical spring for each column (13a).

13. The capping head according to claim 12, wherein the control flange (21) comprises a slider (21a) passed through by the columns (13a) and capable of sliding axially on the columns (13a) due to the presence of sliding bushings (21b), and wherein the slidable drive cam (25) comprises a slider (25a) passed through by the columns (13a) and capable of sliding axially on the columns (13a) due to the presence of the sliding bushings (21b).

14. The capping head according to claim 13, wherein the slider (25a) of the drive cam is connected to the slider (21a) of the control flange by means of sleeves (13b) sliding on the bushings (21b) along the columns (13a) of the support structures (13).

15. The capping head according to claim 1, wherein the drive cam (25) comprises a frustoconical body which has its lower base oriented downwards and is slidably associated with the slide guide of the support structure (13), and wherein said drive cam (25) does not interfere with the outer wall of the housing (31) and can therefore slide vertically with no interference.

16. The capping head according to claim 1, wherein for each pivoting arm (27) an actuating lever (51) is provided cooperating, through a rotating wheel (53), with a cam surface (25b) of the sliding cam (25) in order to actuate the corresponding pivoting arm (27).

17. The capping head according to claim 16, wherein the actuating levers (51) are hinged to the pivoting arms (27) in corresponding hinge pins (55) and are configured as second-class levers, and wherein the pivoting arms (27) are hinged to the support structure (13) in corresponding hinge pins (57) and are configured as first-class levers.

18. A capping machine, characterized in that it comprises one or more capping heads according to claim 1.
